(19) United States
(12) Patent Application Publication
(10) Pub. No.: US 2009/0162024 A1
(43) Pub. Date: Jun. 25, 2009

(54) Intra-Media Demarcation

(75) Inventors: Jason PhilipHenry Bradicich, Apex, NC (US); Jonathan Keith Morgan, Durham, NC (US); Geoffrey Winthrop Corey, Fuquay Varina, NC (US)

Correspondence Address: Jason Bradicich;Terry Oakley, Suite 231-i, 800 West Williams Street, Apex, NC, 27502, US

(73) Assignee: GEEVEE, INC., Apex, NC (US)

(21) Appl. No.: 11/961,058

(22) Filed: Dec. 20, 2007

(51) Int. Cl. H04N 5/93

(52) U.S. Cl. 386/52

(57) ABSTRACT

The invention provides a mechanism to allow users to demarcate a section of a media's timeline at the desire of the user. The system takes an existing media recording (examples include but are not limited to video and audio), obtained through various mechanisms, and allows the user to mark one or more sections of the media's timeline for later reference. The highlighted section data will be stored in such a fashion that the author of the highlights as well as other users may view the highlighted sections of the media while still retaining the ability to experience the media in its entirety. The demarcation data, relating the media to the author of the demarcation, and the demarcation data itself can be stored as meta-data related to the media to be later merged with the media at the time of playback to create the new function of media plus demarcations to be viewed at that time. The enhanced player provides the mechanism to create the demarcations in the first instance, but to replay the combined media (still retaining its original length and form) with the demarcated areas. The original media, therefore, is not modified based on the creation of the demarcated timeline showing portions of the media with elevated importance.

### FIELD OF THE INVENTION

The described invention relates to the field of media editing and media demarcation. The invention describes a mechanism and method for marking a portion of a media timeline, or highlighting some media, for future viewing/hearing/experiencing, saving media meta-data, and enhancing a media player for creating the demarcation data and subsequently, merging in real time the data and the media to allow the demarcated portions of the media timeline to be available to a user of the media.

### BACKGROUND OF THE INVENTION

Media is prolific in the world today. In every aspect of life, media is presented as a way to inform, educate, entertain, and document. Based on the proliferation of media, many mechanisms have been created to record this media. We cannot always be in a position to experience a live media stream of some thing of interest. When a volcano erupts in a remote part of the world or a sporting even occurs whose timing conflicts with other engagements, or a speech is given by a famous orator, people still want to experience these occurrences. To aid in this endeavor to view and witness far flung (in space and or time) events, the means to record an event were developed. The recording of media, examples include but are not limited to audio and video, has moved, over time, from the hands of professionals into the hands of anyone and everyone with the advent of tape recorders, VCRs, DVRs, handheld video cameras, computer video and audio capture programs and cards, etc. Thus, media recording has become a commonplace practice. This practice covers everything from recording on-air broadcasts for personal use to making home movies of friends and relatives. In the present day, this has been extended to making recordings of events in virtual lives experienced through avatars on computers or game consoles.

Now, it also is evident that many people will not want to view an entire event. The majority of a media may not interest someone. A recording of a sporting event may be too long or not of interest as a whole, where as a small portion designated as a key moment based on some person's or group's interest will be desired for viewing. Much of a baseball game may be not relevant. Watching teams switch sides is time consuming without contributing to the real outcome of the game, as an example. Whereas a last inning home run that secures a victory is typically seen as exciting. This is the portion of the recorded baseball game that most baseball fans would want to see. So, the question becomes this: In this case, how do we make that portion of a video that is interesting to most people available while preserving the integrity of the entire video? To give another example, a recording is made of a computer game. In this game, there is a time for the player avatars to travel to a location, prepare for a battle, and then perform in the battle. To some users of the recording of this event, the preparation may be important from an educational perspective. To emerge victorious from this encounter, a viewer may need to know what equipment or abilities were prepared beforehand. So, this portion of the video and audio is the important portion for that person. For others, the battle itself may be the relevant portion. What style of actions did the player avatar perform to succeed in the quest of mission. So, in this case, a different portion of the video and audio is important for that particular viewer.

There exists many systems for editing and replaying media. Manual systems are described in U.S. Pat. Nos. 5,109,482 and 5,029,013. Automated systems are also available as described in U.S. Pat. No. 5,778,137. There are inherent limitations to these types of systems. They deal with video streams rather than a whole video. They may be directed at masses of users whereby a single person or mechanism is allowed to demarcate the edited portions and they do not allow individuals to mark the areas of interest. Also, another limitation is that the editing function creates a new video thereby losing the totality of the original to the end user. The end user is only provided with the portions of the video the person or system responsible for editing deems appropriate. Another example of digital video editing is provided by U.S. Pat. No. 5,237,648. The limitation again is the loss of the entire video related to the clipping made as described by this process. This process also requires a specific frame designation to mark the clip. Other mechanisms do allow users to place a mark at an area of interest in an existing video. Refer to U.S. Pat. No. 7,248,778. There is still a limitation in that the notation refers to a single point in a video. The limitation is evident in that I can get to that point, but what before and after that point is important for understanding or clarifying that frame? So, the problem is that these video clipping systems remove a portion of the video from a larger video stream or file. The clip is now available for viewing, but the context from the larger video is missing because only the clipped portion is available. From these limitations it is evident that an improved intra-media demarcation system is needed. A solution is needed that allows users to demarcate specific sections of some media, such as, but not limited to, audio and video, for later reference and commenting by other viewers while still maintaining the totality of the original media for context.

### SUMMARY OF THE INVENTION

The problem is that media clipping systems remove a portion of the media from a larger media stream or file. The clip is now available for viewing, but the context from the larger media is missing because only the clipped portion is available. From these limitations it is evident that an improved intra-media demarcation system is needed. A solution is needed that allows users to demarcate specific sections of a media for later reference and commenting by other users while still maintaining the original media for context. An intra-media demarcation system is provided as described by the current invention. In a specific embodiment of the invention, a user, referred to as the demarcation author, will experience some media then make a determination on which portion of the media timeline that demarcation author wishes others to make special note of. The demarcation author may demarcate a portion of the timeline of the media with a specific beginning and ending point where something of interest is highlighted. The implementation provides the means for other users, hereby known as viewers, to see this special demarcation and view only this section of the media. While this is true, this implementation retains the media in its entirety, thus also allowing any viewer to view the entire media from beginning to end or any other portion of the media whether that portion is the specifically demarcated section from the demarcation author, or that section contains only a part of the specifically demarcated section, or does not contain any of that demarcated section at all.

Also, in another embodiment the demarcation author may create multiple intra-media demarcations showing multiple sections of the media timeline that is of interest. The viewers now have the same ability to view those sections or the media in its entirety as described above.

This invention allows for the demarcating of portions of the media timeline based on some user's interest in marking said portion for future review by himself or herself or by others. The whole media recording is also maintained in this process thereby allowing the context of the demarcation to be retained and viewed as needed by any user of the system.

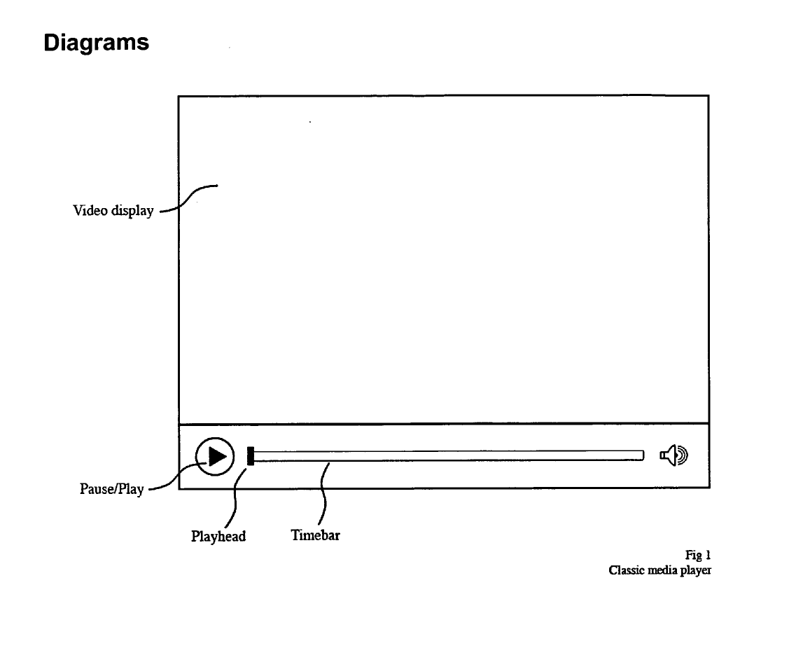

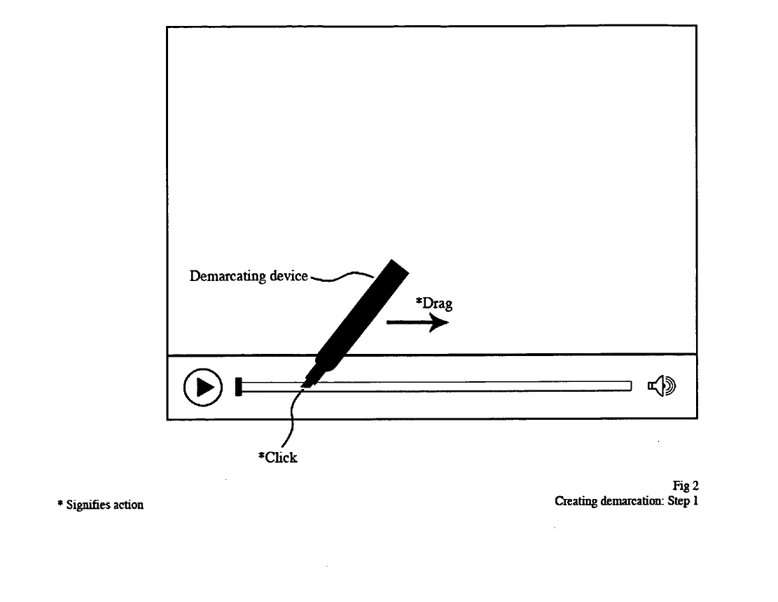

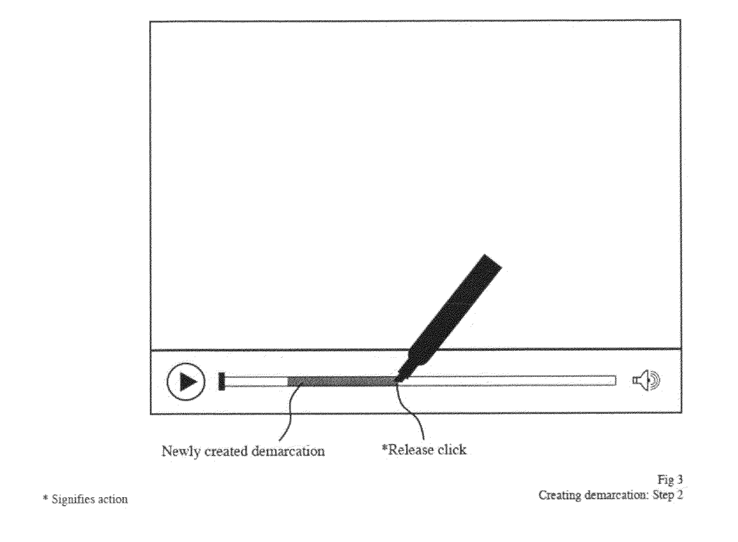

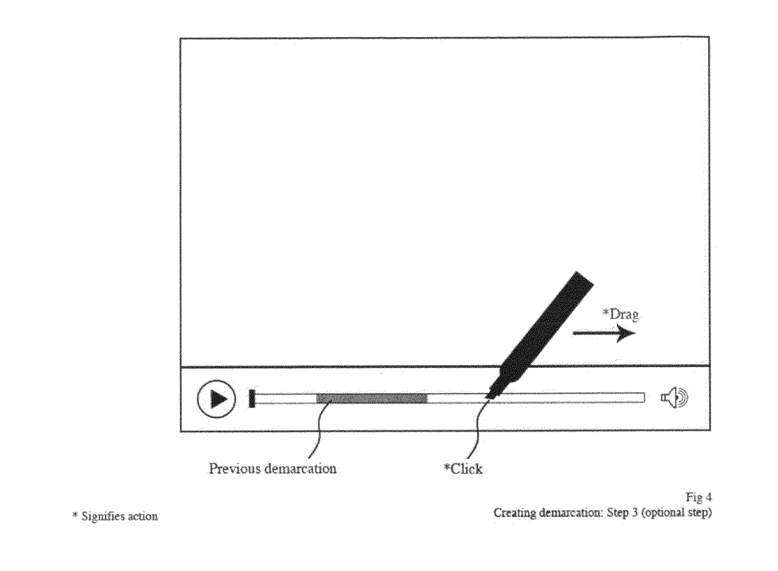

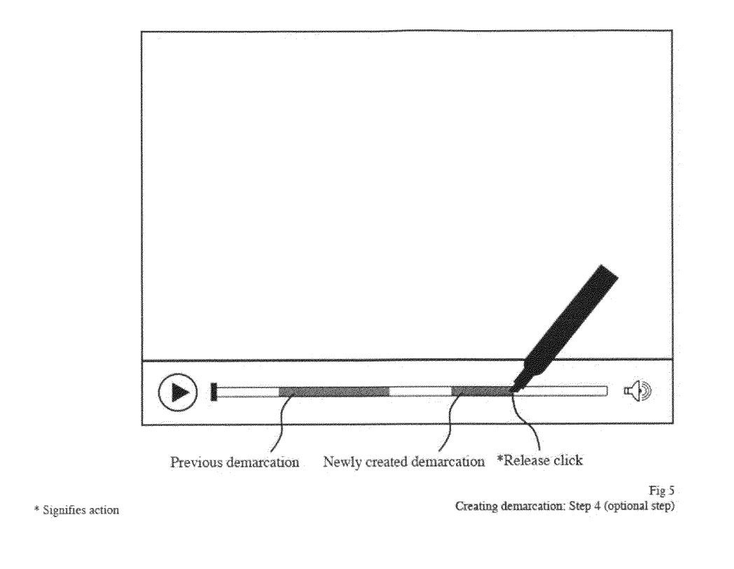

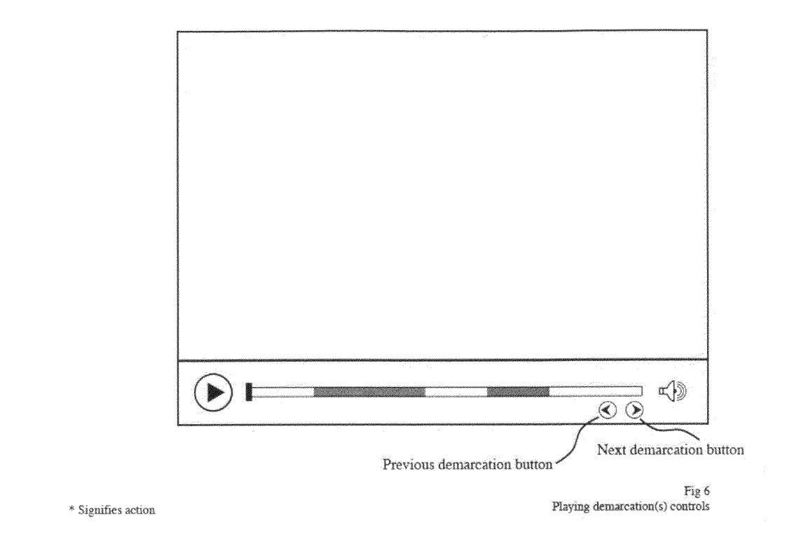

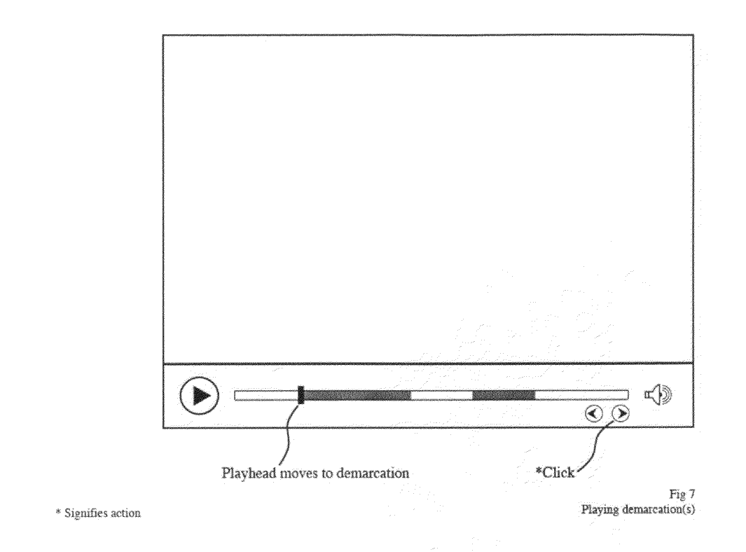

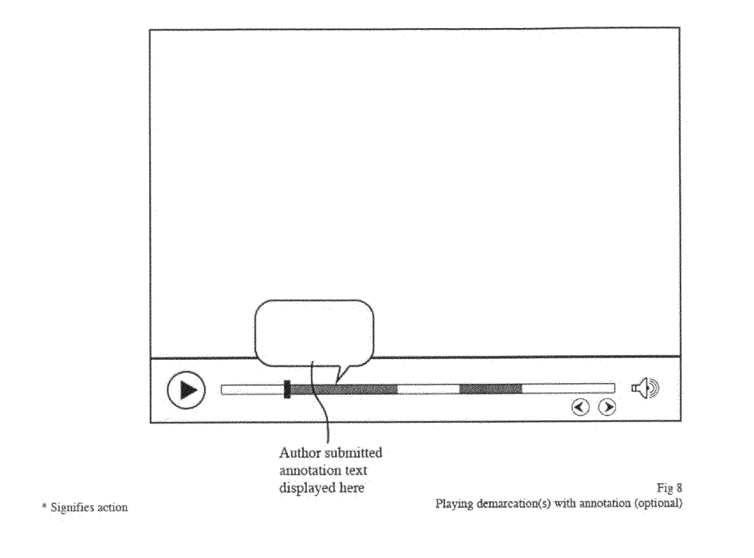

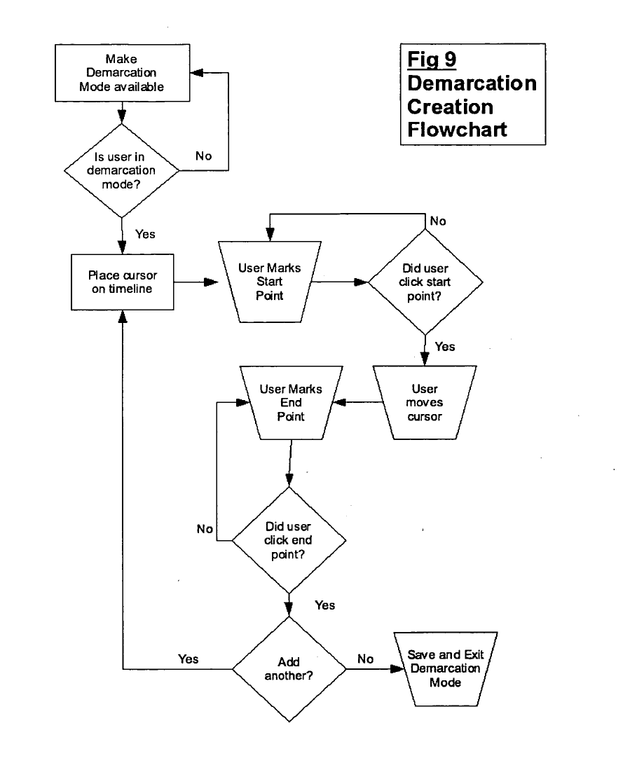

Brief Description of the Figures

| Figure | |
|---|---|
| Number | Description |
| FIG. 1 | Standard media player. |
| FIG. 2 | Media Player with Intra-media demarcation function enabled |
| | showing cursor and demonstrating selection of a start point. |
| FIG. 3 | Media Player with demarcation function active demonstrating |
| | selection of an end point. |
| FIG. 4 | Media Player with demarcation function active demonstrating |
| | selection of a start point for an additional highlighted portion |
| | of the edia timeline. |
| FIG. 5 | Media Player with demarcation function active demonstrating |
| | selection of an ending point for an additional highlighted |
| | section of the media timeline. |
| FIG. 6 | Media Player with previously created demarcations showing |
| | special controls for navigating between demarcations. |
| FIG. 7 | Media Player with previously created demarcations and special |
| | navigation controls showing the playhead at the beginning of a |
| | demarcated section of the media timeline. |
| FIG. 8 | Media player with previously created demarcations also |
| | showing an author annotation giving some additional |
| | information to a viewer of that demarcation. |
| FIG. 9 | Flowchart illustrating the basic flow of creating Intra-Media |
| | Demarcations. |

### DETAILED DESCRIPTION OF THE PREFERRED EMBODIMENT

Downloading and watching or listening to media online or in some player is neither new nor unique. (See FIG. 1) But it does offer some opportunities to add unique flavor and functionality to a website, mobile device, or other computer related device. This is also true for any existing media that you may later view or share with others using other devices.

One such opportunity lies within the ability to demarcate parts of a media's timeline for special attention. Often in long recordings, there may be only specific areas where something important happens. Or there are sections where a certain person, place, or thing appears. How useful would it be to demarcate a certain timed portion of a video and then provide that information to another person. While that other person has the option to view the entirety of the video, they now also have the option to jump right to the section the originator [of the highlight] thought was important. The same could be said for a recorded song or speech. A few seconds of the speech may be the most meaningful for certain users even though the speech lasted for many minutes.

Inter-media highlighting defines the ability to demarcate sections within an existing media's timeline for later playback. The highlighted sections can be experienced, edited, or described by users after the creation of the highlights. This capability works for media players used for streaming or saved media files. Multiple overlapping or sequential highlights may be created on a single media file/recording by multiple users (see FIG. 9.) A user, hereby known as the demarcation author, would view a media recording in an enhanced media player. Media players are common for devices that attach to monitors, television ‘set-top’ devices, computer video players, dedicated player devices, etc. Standard media players with Pause and Play buttons, Timebars with a Playehead, volume Control and Display are well known in the art (see FIG. 1). The enhancement of the media player adds the capability for demarcation authors to mark portions of a medias timeline with starting and ending points, thus creating a section of media showing an area of interest shorter, and contained within, the original media. The media player could indicate the demarcate section through a special highlighted overlay of the normal time progression bar of the player.

The demarcation author would, in the enhanced player, create a beginning mark for the highlighted section of the media timeline by, first, going into the demarcation mode. Once in this mode the cursor, or pointer object on the screen, changes from the default mode to a special cursor object that illustrates that the enhanced player is now in demarcation mode and [the cursor] is attached to the media time progression bar (see FIG. 2). The demarcation author moves the cursor using a cursor movement device including, but not limited to, a mouse, trackball, touch screen, touch pad, etc., to the desired starting point for the demarcation and clicks to indicate this point. The author then moves (or drags) the cursor to the desired ending point and clicks (or releases the click at the end of the drag) to indicate this point (see FIG. 3). This creates the highlighted portion of the media timeline that can be later replayed. To finalize this process, the author most save the work. This is done through a save button or link. At this point, the data is saved to the storage mechanism. Before leaving the demarcation mode in the enhanced editor, the beginning and ending points may also be edited. This editing can take place now, or at a later time. The author of the intra-media demarcation may only edit the media that he/she has created. The author could repeat this process to add additional demarcations to the same media. The process is repeated where the author enters into the demarcation mode and starts to highlight a new portion of the media timeline by clicking at the start point (see FIG. 4) and moving (or dragging) the special cursor and clicking (or releasing the click after a drag) at the point designating the end of the highlighted section (see FIG. 5).

Additionally, the author may add a comment, or annotation, to the highlight. This is useful to provide additional context for a later viewer to describe the reasoning behind the creation of that particular demarcated portion of the media. The data associated with the demarcation is saved to a storage mechanism outside of the media itself, so that the media remains in its original state. This data includes, but is not limited to, the media id, the author's user id, the beginning and ending points of the demarcation, and the annotation.

The media may be loaded into the enhanced player and edited. When the media is loaded, the demarcation data is also loaded so that the enhanced player may create the visual timeline overlay to indicate that there is a section of the timeline that is specially denoted (see FIG. 6). The viewer of the media may now jump directly to this demarcated section through a ‘goto’ button and view only that highlighted section. The player has the typical ‘play’, ‘pause’, ‘rewind’, ‘fast forward’ buttons that are fully functional within the highlighted portion. Again these ‘play control’ functions are common in the art. But the enhanced player has special ‘goto’ functionality possibly, but not limited to, the form of buttons that allow going to the beginning of the Previous highlight or the Next highlight (see FIG. 6). Using these buttons allows the viewer to move the playhead to the beginning of any demarcated area on this media's timeline (see FIG. 7). As the viewer enters a demarcated portion of the media, the annotation associated with this highlight appears in a sub-window. The viewer has the ability to close this sub-window as desired. It will appear again at the next highlight, or the next time this demarcated portion of the media is viewed. The viewer has the ability to turn off the annotation windows altogether if desired. Also, the viewer still has the capability to view the media in its entirety as the demarcation does not effect the original media. If this viewer is also the demarcation author, he/she will have the ability to edit the demarcation and change the starting and ending points.

The enhanced player also allows for other users to create their own demarcations. If a user chooses to create a new demarcated section of the media timeline, the enhanced player again enters demarcation mode allowing this user to become a demarcation author and to perform the same activities in marking a portion of the media for later viewing. The enhanced player stores the data associated with this new demarcation, which includes information on the media identification, the beginning and end points of the demarcation, and the user identity, in a storage mechanism to associate this media and demarcation with this particular demarcation author.

As other viewers view the media, based on, but not limited to, their choice, the access to the media based on placement criteria, or links on a webpage, the media with the appropriate author's demarcated timeline segments are loaded into the player for viewing and, possibly, editing purposes based on definable criteria.

We claim:

1. A system and method for intra-media demarcation that allows:
a. users to specify a section of a media (demarcating a time by indicating the starting and ending times on the media's timeline) with a start and end point for special notice using an enhanced media player.
b. the demarcation to be viewed by said user or other users in an enhanced media player.
c. the media being thus highlighted to still maintain its integrity and totality. The method of creating this highlight allows for user interaction on an existing media, whereby the media is stored as digital, tape, optical, or other media.
d. the demarcation is stored in such a way that the originating user or other users may experience this highlight as an integrated part of the media while maintaining the ability to experience the media as a whole.

2. The system and method in claim 1 further allowing multiple demarcations in a single media.

3. The system and method in claim 1 further allowing multiple users the ability to create demarcations for a single file.

4. The system and method in claim 1 further allowing descriptions to be added by the user for a created highlight.

5. The system and method in claim 1 further allowing navigation between demarcation beginning and end points.

6. The system and method in claim 1 further allowing users to explicitly designate the start and end points through a clickable interface where the start and end points are manually clicked (designated.)

7. The system and method in claim 6 further allowing the start and end point to be adjusted after the initial setting.

8. The system and method in claim 1 further allowing the entire highlight to be selected for view.

9. The system and method in claim 1 further allowing the start point to be designated through a click with a pointing device (example: a computer mouse, touchpad, wheel, trackball, stylus, touchscreen, etc) and the highlight length created through a drag motion extending the highlight until release of the click.

10. The system and method in claim 1 further allowing that the highlight may be created with a drag of a stylus or human appendage across a touchscreen on the media representation to advance or retract the media to designate the start and end points.

11. The system and method in claims 1, 6, 9, and 10 further allowing the cursor to change shape or icon to represent the highlighting function while active.

12. The system and method in claims 1, 6, 9, and 10 further specifying that the start and end points are not queue points as defined in programming library structures but rather the demarcations for a section of media.

13. The system and method in claim 2 further allowing that multiple highlights may overlap one another.

14. The system and method in claim 2 further allowing that multiple highlights may be sequential and may not overlap one another.

15. The system and method in claims 11 further allowing that the changed cursor, indicating that the highlight functionality is active, defines the precision of the start and end point definitions.

16. The system and method in claim 1 further allowing that the media time position will move (or ‘scrub’) with the cursor as the highlight is created, allowing the media to show the exact moment the beginning and end points are designated.

17. The method in claim 1 further allowing a player showing a remote media to jump to a highlighted section and start the download at that point in the file if this is a remote media.

18. The system and method in claim 1 further allowing a player to begin a media file at the start of a highlight rather than at the start of the media itself based on user or administrator input. This input may be stored as a setting or may be explicitly chosen for a particular media or viewing session.

19. The system and method in claim 1, 2, 3, and 4 further allowing the enhanced player to save the meta-data associated with a demarcation to be stored independently of the media in a data storage mechanism such as, but not limited to, a database table or data object.

20. The system and method in claim 1, 2, 3, and 4 further allowing the enhanced player to save the meta-data associated with a demarcation to be as meta-data on the media itself as additional meta-data as the file format permits.
